(19) United States
(12) Patent Application Publication
(10) Pub. No.: US 2021/0195029 A1
(43) Pub. Date: Jun. 24, 2021

(54) SPEECH PACE BASED INTELLIGENT AGENT SELECTION

(71) Applicant: Avaya Inc., Santa Clara, CA (US)

(72) Inventors: Ishaan Aggarwal, Ghaziabad (IN); Divakar Kumar Ray, Pune (IN); Anjum Siddique, Pune (IN)

(21) Appl. No.: 16/726,627

(22) Filed: Dec. 24, 2019

(51) Int. Cl. H04M 3/523; G06Q 30/00; G06Q 10/06; G10L 15/22; G10L 15/00

(52) U.S. Cl. CPC H04M 3/5232; G06Q 30/016; H04M 2203/558; G10L 15/22; G10L 15/005; G06Q 10/063112

(57) ABSTRACT

Humans often understand speech at a rate closing matching their own rate of speech. However, this is an average and natural speech will have a fluctuating rate of speech. Mandating that a must speak at a certain rate, such as to accommodate the preferred rate of another person, is distracting to the speaker and often results in a noticeably unnatural patter of speech. By automatically identifying a preferred speaking rate, a customer of a contact center may automatically be matched to an agent who naturally speaks at the same rate, with an acceptable margin of error, as the customer. Accordingly, the selected agent requires no coaching with regard to the rate of speech and may naturally converse with the customer.

### COPYRIGHT NOTICE

A portion of the disclosure of this patent document contains material that is subject to copyright protection. The copyright owner has not objected to the facsimile reproduction by anyone of the patent document or the patent disclosure as it appears in the Patent and Trademark Office patent files or records, but otherwise reserves all copyright rights whatsoever.

### FIELD OF THE DISCLOSURE

The invention relates generally to systems and methods for networking and particularly to alerting a network topology to enable a specified communication thereon.

### BACKGROUND

Contact centers strive to provide the best experience for the customers of the contact center. When a customer has an interaction with a live agent, it is important that the interaction go smoothly and quickly to resolve the issue or other reason for the interaction. Communications between the live agent and the customer is often a critical component to ensuring a successful resolution of the issue or, if not resolved, the reason for the lack of resolution should not be a result of the communication itself.

### SUMMARY

Spoken communication between a live agent (herein, “agent”) and a customer, such as utilizing a telephone or voice-chat channel may fail to successfully resolve the issue for the communication when the communication between the agent and customer is difficult for one or both parties to understand the other. Customers may find it difficult to understand what the agent is saying because they might be speaking too fast (more words per minute) than a customer is able to understand. Similarly, a customer who can understand faster paced speech may get irritated when the agent is speaking at too slow of a pace.

In one embodiment, intelligent selection of an agent is provided. The selection of the agent considers the pace of speech (words/min) for the available agents and the customer to best select an agent to match the speaking pace of the customer. As a benefit, the agent-customer interaction may better facilitate understanding and hence, better satisfaction to the customer and prompt resolution of the issue that prompted the interaction.

One technique for facilitating effective and efficient communications is an age-based matching of the customer to a particular agent. A drawback of age-based matching is that pace of speech is affected by more than just age of the speaker. Speech pace, and hence understanding pace, may be independent of age or dependent on age in combination with another factor. For example, region, native language, may impact speaking pace more than age alone. Additionally, individual differences may impact speech pace. For example, a mentally active 50 year old person may have better comprehension and understanding than a 40 year old that is not mentally active. With age, the pace of speech will often change as well. Agents may need periodic evaluation to update records associated with pace of speech.

In another embodiment, systems and methods are provided that assess and/or periodically or on demand re-assess the pace of speech for the agent and/or customer. During a call, the pace of speech of the agent and/or customer may be determined and utilized for routing a call so that the customer interacts with an agent that has a similar, or most similar, pace of speech. Additionally, or alternatively, the information gathered in one call, such as the content of the call itself, may be utilized in a subsequent routing decision.

In another embodiment, pace of speech may be determined indirectly, such as based on a customer's age, geographic region, day, time of day, etc. that may be associated with a particular pace or impact on speaking pace. Once the pace of a customer is determined, the customer, via their customer communication device, is connected via a network to an agent, via the particular agent communication device associated with the selected agent, having a greater degree of match of speech pace to improve understanding and facilitate effective resolution behind the reason for the interaction.

These and other needs are addressed by the various embodiments and configurations of the present invention. The present invention can provide a number of advantages depending on the particular configuration. These and other advantages will be apparent from the disclosure of the invention(s) contained herein.

In one embodiment, a system is disclosed, comprising: a microprocessor having a non-transitory memory comprising machine-readable instructions; a network interface to a network; and wherein the microprocessor performs: accessing a communication, via the network, with a customer communication device associated with a customer and comprising an audio portion; accessing a customer pace of speech associated with the customer; accessing an agent pace of speech associated with each of a number of agents available to join the communication via their respective agent communication device; selecting an agent, from the number of agents, that has the associated agent pace of speech that most closely matching the customer pace of speech; and configuring the network to cause the selected agent, via the selected agent's respective agent communication device, to join the communication.

In another embodiment, a method is disclosed, comprising: accessing a communication, utilizing a network, with a customer communication device associated with a customer and comprising an audio portion; accessing a customer pace of speech associated with the customer; accessing an agent pace of speech associated with each of a number of agents available to join the communication via their respective agent communication device; selecting an agent, from the number of agents, that has the associated agent pace of speech that most closely matching the customer pace of speech; and configuring the network to cause the selected agent, via the selected agent's respective agent communication device, to join the communication.

In another embodiment, a system is disclosed, comprising: means to access a communication, utilizing a network, with a customer communication device associated with a customer and comprising an audio portion; means to access a customer pace of speech associated with the customer; means to access an agent pace of speech associated with each of a number of agents available to join the communication via their respective agent communication device; means to select an agent, from the number of agents, that has the associated agent pace of speech that most closely matching the customer pace of speech; and means to configure the network to cause the selected agent, via the selected agent's respective agent communication device, to join the communication.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incoiporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a second system in accordance with embodiments of the present disclosure;

FIG. 3 depicts a first data structure in accordance with embodiments of the present disclosure;

FIG. 4 depicts a second data structure in accordance with embodiments of the present disclosure;

FIG. 5 depicts a users' age distribution in accordance with embodiments of the present disclosure;

FIG. 6 depicts a third data structure in accordance with embodiments of the present disclosure;

FIG. 7 depicts a process in accordance with embodiments of the present disclosure;

FIG. 8 depicts a second process in accordance with embodiments of the present disclosure; and

FIG. 9 depicts a third system in accordance with embodiments of the present disclosure

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a subelement identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

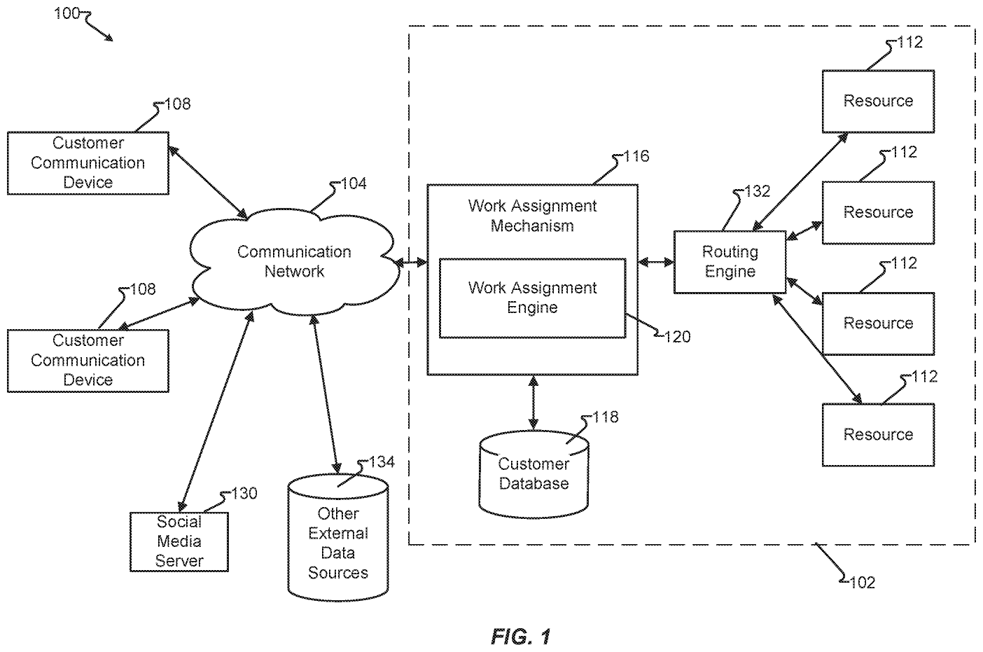

With reference now to FIG. 1, communication system 100 is discussed in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering contact center 102 in which a plurality of resources 112 is distributed to handle incoming work items (in the form of contacts) from customer communication devices 108.

Contact center 102 is variously embodied to receive and/or send messages that are or are associated with work items and the processing and management (e.g., scheduling, assigning, routing, generating, accounting, receiving, monitoring, reviewing, etc.) of the work items by one or more resources 112. The work items are generally generated and/or received requests for a processing resource 112 embodied as, or a component of, an electronic and/or electromagnetically conveyed message. Contact center 102 may include more or fewer components than illustrated and/or provide more or fewer services than illustrated. The border indicating contact center 102 may be a physical boundary (e.g., a building, campus, etc.), legal boundary (e.g., company, enterprise, etc.), and/or logical boundary (e.g., resources 112 utilized to provide services to customers for a customer of contact center 102).

Furthermore, the border illustrating contact center 102 may be as-illustrated or, in other embodiments, include alterations and/or more and/or fewer components than illustrated. For example, in other embodiments, one or more of resources 112, customer database 118, and/or other component may connect to routing engine 132 via communication network 104, such as when such components connect via a public network (e.g., Internet). In another embodiment, communication network 104 may be a private utilization of, at least in part, a public network (e.g., VPN); a private network located, at least partially, within contact center 102; or a mixture of private and public networks that may be utilized to provide electronic communication of components described herein. Additionally, it should be appreciated that components illustrated as external, such as social media server 130 and/or other external data sources 134 may be within contact center 102 physically and/or logically, but still be considered external for other purposes. For example, contact center 102 may operate social media server 130 (e.g., a website operable to receive user messages from customers and/or resources 112) as one means to interact with customers via their customer communication device 108.

Customer communication devices 108 are embodied as external to contact center 102 as they are under the more direct control of their respective user or customer. However, embodiments may be provided whereby one or more customer communication devices 108 are physically and/or logically located within contact center 102 and are still considered external to contact center 102, such as when a customer utilizes customer communication device 108 at a kiosk and attaches to a private network of contact center 102 (e.g., WiFi connection to a kiosk, etc.), within or controlled by contact center 102.

It should be appreciated that the description of contact center 102 provides at least one embodiment whereby the following embodiments may be more readily understood without limiting such embodiments. Contact center 102 may be further altered, added to, and/or subtracted from without departing from the scope of any embodiment described herein and without limiting the scope of the embodiments or claims, except as expressly provided.

Additionally, contact center 102 may incorporate and/or utilize social media server 130 and/or other external data sources 134 may be utilized to provide one means for a resource 112 to receive and/or retrieve contacts and connect to a customer of a contact center 102. Other external data sources 134 may include data sources, such as service bureaus, third-party data providers (e.g., credit agencies, public and/or private records, etc.). Customers may utilize their respective customer communication device 108 to send/receive communications utilizing social media server 130.

In accordance with at least some embodiments of the present disclosure, the communication network 104 may comprise any type of known communication medium or collection of communication media and may use any type of protocols to transport electronic messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type and instead may be comprised of a number of different networks and/or network types. As one example, embodiments of the present disclosure may be utilized to increase the efficiency of a grid-based contact center 102. Examples of a grid-based contact center 102 are more fully described in U.S. Patent Publication No. 2010/0296417 to Steiner, the entire contents of which are hereby incorporated herein by reference. Moreover, the communication network 104 may comprise a number of different communication media, such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item. Illustrative work items include, but are not limited to, a contact directed toward and received at a contact center 102, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication, such as social media server 130. An example of such a harvested communication includes a social media communication that is harvested by the work assignment mechanism 116 from a social media network or server 130. Exemplary architectures for harvesting social media communications and generating work items based thereon are described in U.S. patent application Ser. Nos. 12/784,369, 12/706,942, and 12/707,277, filed Mar. 20, 2010, Feb. 17, 2010, and Feb. 17, 2010, respectively; each of which is hereby incorporated herein by reference in its entirety.

The format of the work item may depend upon the capabilities of the communication device 108 and the format of the communication. In particular, work items are logical representations within a contact center 102 of work to be performed in connection with servicing a communication received at contact center 102 (and, more specifically, the work assignment mechanism 116). The communication may be received and maintained at the work assignment mechanism 116, a switch or server connected to the work assignment mechanism 116, or the like, until a resource 112 is assigned to the work item representing that communication. At which point, the work assignment mechanism 116 passes the work item to a routing engine 132 to connect the communication device 108, which initiated the communication, with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general, each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item is sent toward a collection of processing resources 112 via the combined efforts of the work assignment mechanism 116 and routing engine 132. The resources 112 can either be completely automated resources (e.g., Interactive Voice Response (IVR) units, microprocessors, servers, or the like), human resources utilizing communication devices (e.g., human agents utilizing a computer, telephone, laptop, etc.), or any other resource known to be used in contact center 102.

As discussed above, the work assignment mechanism 116 and resources 112 may be owned and operated by a common entity in a contact center 102 format. In some embodiments, the work assignment mechanism 116 may be administered by multiple enterprises, each of which has its own dedicated resources 112 connected to the work assignment mechanism 116.

In some embodiments, the work assignment mechanism 116 comprises a work assignment engine 120, which enables the work assignment mechanism 116 to make intelligent routing decisions for work items. In some embodiments, the work assignment engine 120 is configured to administer and make work assignment decisions in a queueless contact center 102, as is described in U.S. patent application Ser. No. 12/882,950, the entire contents of which are hereby incorporated herein by reference. In other embodiments, the work assignment engine 120 may be configured to execute work assignment decisions in a traditional queue-based (or skill-based) contact center 102.

The work assignment engine 120 and its various components may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users. Work assignment mechanism 116 may access customer database 118, such as to retrieve records, profiles, purchase history, previous work items, and/or other aspects of a customer known to contact center 102. Customer database 118 may be updated in response to a work item and/or input from resource 112 processing the work item.

It should be appreciated that one or more components of contact center 102 may be implemented in a cloud-based architecture in their entirety, or components thereof (e.g., hybrid), in addition to embodiments being entirely on-premises. In one embodiment, customer communication device 108 is connected to one of resources 112 via components entirely hosted by a cloud-based service provider, wherein processing and data storage elements may be dedicated to the operator of contact center 102 or shared or distributed amongst a plurality of service provider customers, one being contact center 102.

In one embodiment, a message is generated by customer communication device 108 and received, via communication network 104, at work assignment mechanism 116. The message received by a contact center 102, such as at the work assignment mechanism 116, is generally, and herein, referred to as a “contact.” Routing engine 132 routes the contact to at least one of resources 112 for processing.

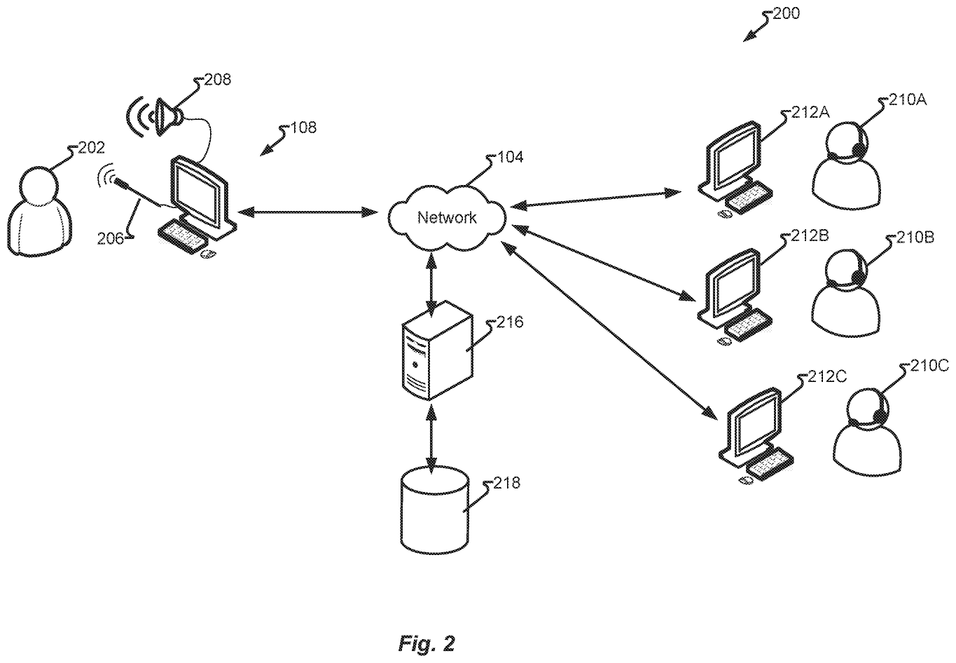

FIG. 2 depicts system 200 in accordance with embodiments of the present disclosure. As illustrated and described with respect to FIG. 1, contact center 102 may utilize various embodiments for resources 112 and may include human (or “live”) agents utilizing an agent communication device for conversion to encoded signals to be conveyed to the customer via communication network 104, as well as, automated agents (e.g., expert systems, interactive voice response, etc.). In the embodiments that follow, resources 112 are embodied solely as live agents 210 utilizing their respective agent communication device 212 and excludes automated or other machine-based agents.

Agent 210, such as each of agent 210A-C, are each associated with a respective agent communication device 212, that is a corresponding one of agent communication device 212A-C. It should be appreciated that only three agents 210 and three corresponding agent communication device 212 are illustrated to avoid unnecessarily complicating the figures and description. In another embodiment, two or more agents 210 and associated two or more agent communication devices 212 may be utilized. In other, more real-world, embodiments the number of agents 210 and associated agent communication devices 212 may number in the hundreds or thousands. Agent communication device 212 comprises a speaker/microphone, such as in the form of a headset, to convert sound energy into and from encoded communication signals for transport via communication network 104. In other embodiments agent communication device 212 may support additional forms of communication, such as video, co-browsing, etc. in addition to audio in the form of speech.

Customer 202 may utilize customer communication device 108 that is variously embodied but, herein, comprises at least speaker 208 to present encoded audio data, such as speech originating from one of agent 210, into sound energy. Microphone 206 may be utilized to capture speech from customer 202 for encoding for transport via communication network 104, which may then be presented as sound energy to a particular agent 210 engaged in the communication with customer 202.

In another embodiment, communication server 216 may be embodied as, co-embodied with, or embodied by one or more of work assignment mechanism 116 and/or work assignment engine 120 and execute routing decisions, such as to enable communication network 104 to comprise a first node, such as customer communication device 108, and a particular second node, such as a selected one of agent communication device 212A-C. Routing database 218 may comprise data, such as in the form of data structures illustrated with respect to certain embodiments that follow, rules, algorithms, machine-readable and executable instructions, etc. Routing database 218 may be embodied as a storage for data in the form of a storage device or component or other non-transitory storage and be accessible to a microprocessor (not shown), such as of communication server 216 to determine and execute network configuration decisions. For example, customer 202 may be determined to have a particular customer attribute and such an attribute is associated directly or via an intermediary attribute with a pace of speech most closing matching agent 210B. Accordingly, communication server 216 may access data and/or rules in routing database 218 to make such a determination and cause communication network 104 to be configured to include agent communication device 212B into the communication with customer communication device 108 for customer 202. As a result, agent 210 may speak at their natural pace, which allows agent 210 to have fewer distractions to provide resolution to the work item that motivated the communication. As an additional benefit, normal variations in human speech, including speaking pace, are provided by agent 210B naturally and without the burden and distraction of providing a prompt to agent 210B. Agent 210B may speak naturally, including natural variations in speaking pace, and better engage with customer 202 to resolve the particular work item and successfully conclude the communication.

In another embodiment, data for customer 202 may be maintained in routing database 218 and/or customer database 118, such as a known pace of speech for customer 202 for use in routing a subsequent communication with customer 202 to a particular agent 210 having a similar pace of speech. As will be discussed more completely with respect to certain embodiments that follow, determining a customer's rate of speech may be determined indirectly, such as by utilization of a correlated value, such as age. In other embodiments, other correlations may be utilized, such as education, occupation, geographic region of current or original residence, etc.

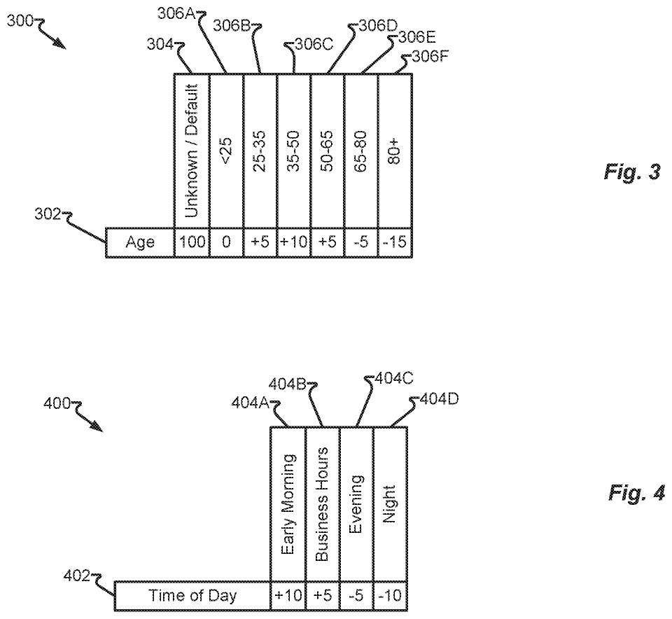

FIG. 3 depicts data structure 300 in accordance with embodiments of the present disclosure. In one embodiment, data structure 300 comprises record 302 with elements 304 and 306A-306F, each indicating a value for the age of customer 202 and associated value for pace of speech or alteration thereof. In one embodiment, data structure 300 is accessed by a microprocessor, such as of communication server 216, to determine a customer rate of speech indirectly, namely from the age of customer 202. It should be appreciated the values in record 302 may be absolute, such as 100 (words-per-minute), for an unknown or default age associated with element 304 or a modification, such as to add ten words-per-minute if the age is between 35 and 50, as indicated by element 306C.

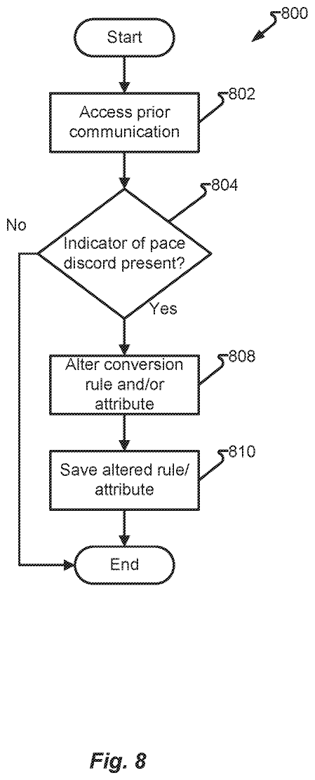

FIG. 4 depicts data structure 400 in accordance with embodiments of the present disclosure. In one embodiment, data structure 400 comprises record 402 with elements 404A-404D, each indicating a value for a time of day associated for when customer 202 originated the communication. The determination of the values for record 402 is variously embodied. In one embodiment, a history of calls may determine that, for example, those that call early in the morning are able and wanting to obtain information more quickly, such as by being paired with a particular agent 210 that speaks ten works-per-minute faster than a normal or baseline pace. Means to determine if a particular communication was conducted at a too fast or too slow of a pace are discussed more thoroughly with respect to FIG. 8.

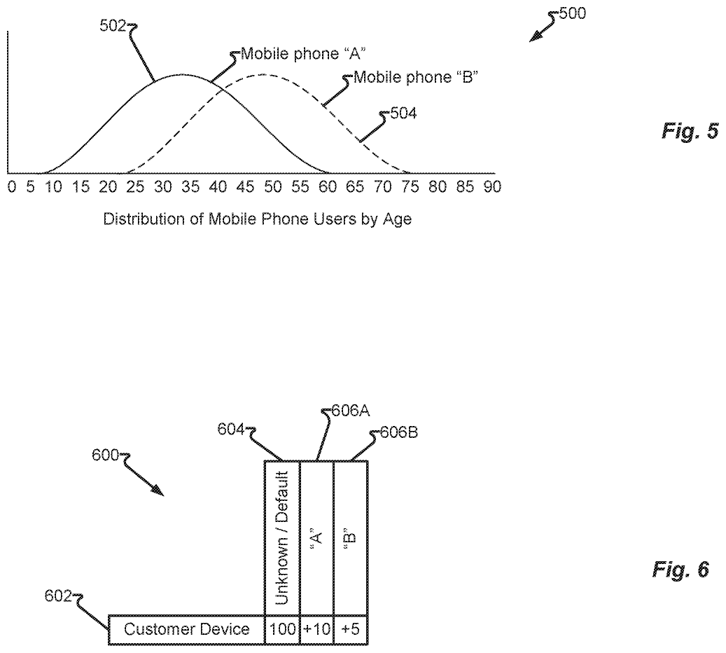

FIG. 5 depicts users' age distribution 500 in accordance with embodiments of the present disclosure. Customer 202 may have a preferred pace of speech and better communicate with others, including one of agents 210 that has a similar pace of speech. In one embodiment, the age of customers who use a particular mobile phone may be known, such as via a distribution curve. In one embodiment, mobile phone “A” may have a customer base with a distribution of ages graphed as curve 502. Similarly, the users of mobile phone “B” have an age distribution graphed as curve 504. Accordingly, if a call is received and the identity of the customer communication device 108 indicates one of mobile phone “A” or “B”, then the determined age of the customer, if not otherwise known, may be estimated and/or modified according to their device type. For example, the average user of mobile phone “A” may be assumed to be 33 (the peak of curve 502), whereas the average user of mobile phone “B” may be assumed to be 48 (the peak of curve 504). Additionally, or alternatively, if the customer speaking pace or age of customer 202 is otherwise determined, as a non-absolute value, their particular mobile phone may be used to increase the estimated age, such as for a user of mobile phone “B” or decrease the estimated age, such as for a user of mobile phone “A”.

FIG. 6 depicts data structure 600 in accordance with embodiments of the present disclosure. In one embodiment, data structure 600 may be derived from users' age distribution 500 such as a microprocessor may determine or modify a determined speaking pace for customer 202 based, at least in part, on the particular customer communication device 108 utilized. Accordingly, data structure 600 comprises record 602 with entries 604 and 606A-B for the particular mobile device utilized by customer 202 or, if unknown, a default value as indicated by entry 604.

Data structures 300, 400, and 600, and/or other data structures may be combined, separated, or modified without departing from the scope of the embodiments here. As described, data structures 300, 400, and 600 illustrate various means to indirectly determining customer's pace of speech by estimating a sufficiently correlated customer attribute, such as the age of the customer.

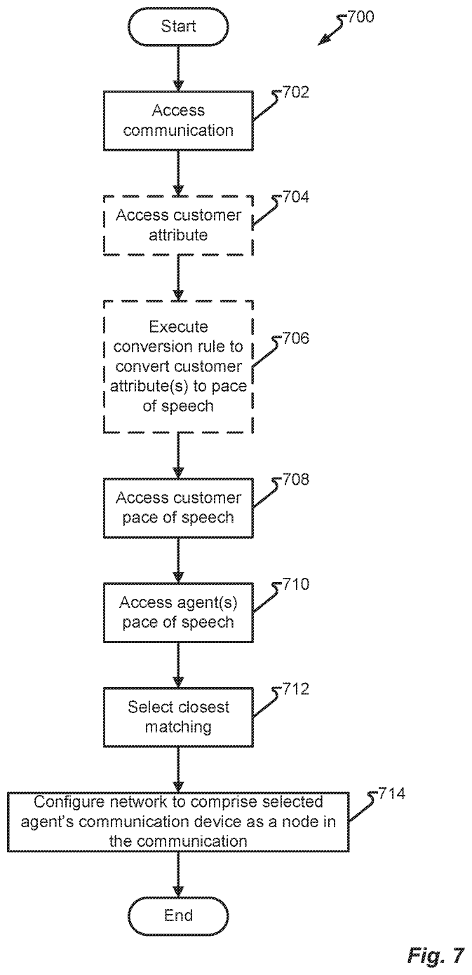

FIG. 7 depicts process 700 in accordance with embodiments of the present disclosure. In one embodiment, process 700 is maintained as machine-readable and executable instructions for execution by a microprocessor, such as a microprocessor of communication server 216. In one embodiment process 700 begins and a communication with customer 202 via an associated customer communication device 108 is accessed in step 702. Optionally, step 704 accesses a customer attribute for customer 202, if available, such as by retrieving a customer record from routing database 218 and/or customer database 118. Optional step 706 coverts the customer attribute into a pace of speech, such as by use of data structures 300, 400, and/or 600 and/or other formula or rule. Upon execution of step 706, if implemented, step 708 accesses the pace of speech for customer 202. Steps 704 and 706 may be omitted if the pace of speech is already known, for example, customer 202 is known in routing database 218 and comprises an explicit entry for their pace of speech.

Next, step 710 accesses the pace of speech for agent 210, such as from a non-transitory data storage. Step 710 may be limited to agents 210 that are currently available, or are predicted to soon become available, to be joined to a communication with customer 202 without excessive delay. By way of design choice, the particular strength of a match between an agent's pace of speech and a customer's pace of speech may be balanced against time on hold waiting for that particular agent to become available. For example, while it may be of little consequence to have a customer wait ten seconds for a match to an agent that has a pace of speech within an acceptable deviation (e.g., +/−5%), however, in certain implementations, it may be preferable to have the customer wait a little longer, such as thirty seconds, for a more exact match (e.g., +/−0.3%) that is believed to become available during that time.

Next, step 712 selects one of the agents 210 that has a pace of speech that matches, or most closely matches, that of customer 202. Step 714 the causes the communication with customer communication device 108, utilized by customer 202, to be connected to the agent communication device 212 associated with the agent 210 selected in step 712.

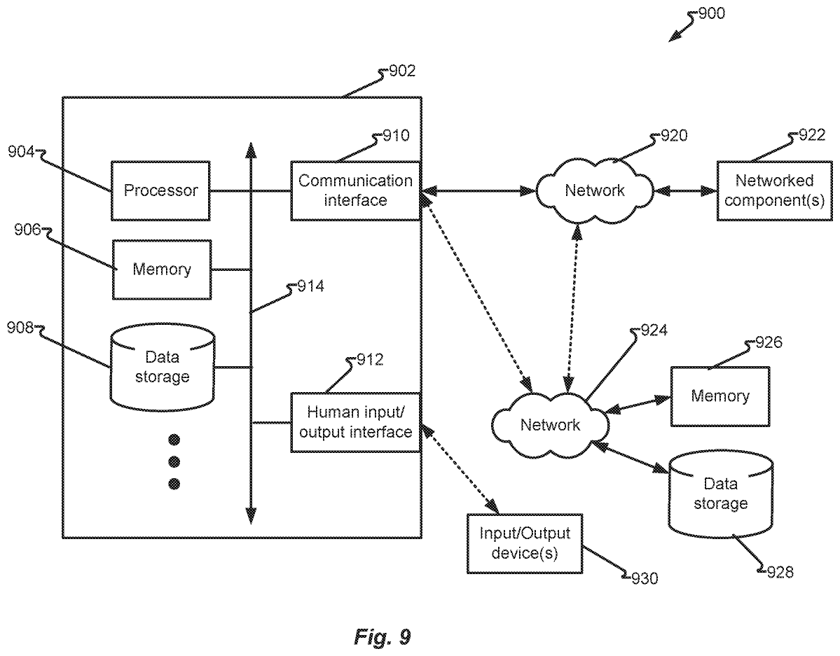

FIG. 9 depicts process 800 in accordance with embodiments of the present disclosure. In one embodiment, process 800 may be executed by a microprocessor, such as by communication server 216 and/or a microprocessor associated with a different computing device. In one embodiment, process 800 is initiated after a selected agent 210 has been joined to the communication with customer 202 and step 802 is executed while the communication is ongoing. In another embodiment, the communication has concluded and step 802 accesses a data storage having a transcript or audio recording of the, now concluded, communication.

Next, test 804 determines if an indication of a pace of speech discord is present. A discord exists when a customer, such as customer 202 is matched to a particular agent 210, but the pace of speech provided by the particular agent 210 is not in accord with that of customer 202. This may indicate that an assumption (e.g., rule or data structure) is in error, that information gathered is in error, and/or other error is present. An indication of discord, in the form of the particular agent 210 speaking too quickly may include determining that the communication comprises cues for the agent to slow down, including, but not limited to, customer 202 saying, “you're talking to fast,” “wait a second,” “say that again,” “did you say . . . ?”, etc. Conversely, an indication of discord, in the form of the particular agent 210 speaking too slowing may include determining that the communication comprises cues for the agent to speed up, including, but not limited to, customer 202 saying, “I get it,” “let's move on,” talking over the agent, finishing the agent's sentence, etc. Additionally or alternatively, customer 202 may expressly indicate the discord, such as in an in-call or post-call review comprising specific indication that the agent talked too fast or too slow.

Accordingly, step 808 may be executed to attenuate the difference. For example, if it is determined that there is a correlation between a particular customer attribute and their pace of speech, a new data structure and/or modification to an existing data structure may be provided, such as to indicate that customers over eighty years old generally have twenty-five words per minute few than a baseline. Step 810 then saves the altered rule or attribute, such as in database 218. As a result, the data and/or rules utilized to determine a customer's rate of speech may be dynamically and automatically updated without any human intervention.

FIG. 9 depicts device 902 in system 900 in accordance with embodiments of the present disclosure. In one embodiment, agent communication device 212 and/or customer communication device 108 may be embodied, in whole or in part, as device 902 comprising various components and connections to other components and/or systems. The components are variously embodied and may comprise processor 904. Processor 904 may be embodied as a single electronic microprocessor or multiprocessor device (e.g., multicore) having therein components such as control unit(s), input/output unit(s), arithmetic logic unit(s), register(s), primary memory, and/or other components that access information (e.g., data, instructions, etc.), such as received via bus 914, executes instructions, and outputs data, again such as via bus 914.

In addition to the components of processor 904, device 902 may utilize memory 906 and/or data storage 908 for the storage of accessible data, such as instructions, values, etc. Communication interface 910 facilitates communication with components, such as processor 904 via bus 914 with components not accessible via bus 914. Communication interface 910 may be embodied as a network port, card, cable, or other configured hardware device. Additionally or alternatively, human input/output interface 912 connects to one or more interface components to receive and/or present information (e.g., instructions, data, values, etc.) to and/or from a human and/or electronic device. Examples of input/output devices 930 that may be connected to input/output interface include, but are not limited to, keyboard, mouse, trackball, printers, displays, sensor, switch, relay, etc. In another embodiment, communication interface 910 may comprise, or be comprised by, human input/output interface 912. Communication interface 910 may be configured to communicate directly with a networked component or utilize one or more networks, such as network 920 and/or network 924.

Communication network 104 may be embodied, in whole or in part, as network 920. Network 920 may be a wired network (e.g., Ethernet), wireless (e.g., WiFi, Bluetooth, cellular, etc.) network, or combination thereof and enable device 902 to communicate with network component(s) 922.

Additionally or alternatively, one or more other networks may be utilized. For example, network 924 may represent a second network, which may facilitate communication with components utilized by device 902. For example, network 924 may be an internal network to contact center 102 whereby components are trusted (or at least more so) that networked components 922, which may be connected to network 920 comprising a public network (e.g., Internet) that may not be as trusted. Components attached to network 924 may include memory 926, data storage 928, input/output device(s) 930, and/or other components that may be accessible to processor 904. For example, memory 926 and/or data storage 928 may supplement or supplant memory 906 and/or data storage 908 entirely or for a particular task or purpose. For example, memory 926 and/or data storage 928 may be an external data repository (e.g., server farm, array, “cloud,” etc.) and allow device 902, and/or other devices, to access data thereon. Similarly, input/output device(s) 930 may be accessed by processor 904 via human input/output interface 912 and/or via communication interface 910 either directly, via network 924, via network 920 alone (not shown), or via networks 924 and 920.

It should be appreciated that computer readable data may be sent, received, stored, processed, and presented by a variety of components. It should also be appreciated that components illustrated may control other components, whether illustrated herein or otherwise. For example, one input/output device 930 may be a router, switch, port, or other communication component such that a particular output of processor 904 enables (or disables) input/output device 930, which may be associated with network 920 and/or network 924, to allow (or disallow) communications between two or more nodes on network 920 and/or network 924. For example, a connection between one particular customer, using a particular customer communication device 108, may be enabled (or disabled) with a particular networked component 922 and/or particular agent communication device 212. Similarly, one particular networked component 922 and/or resource 112 may be enabled (or disabled) from communicating with a particular other networked component 922 and/or agent communication device 212, including, in certain embodiments, device 902 or vice versa. Ones of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARIV1926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

1. A system, comprising:
a microprocessor having a non-transitory memory comprising machine-readable instructions;
a storage, the storage being a non-transitory data storage accessible to the microprocessor;
a network interface to a network; and
wherein the microprocessor performs:
accessing a communication, via the network, with a customer communication device associated with a customer and comprising an audio portion;
accessing a customer pace of speech associated with the customer;
accessing an agent pace of speech associated with each of a number of agents available to join the communication via their respective agent communication device;
selecting an agent, from the number of agents, that has the associated agent pace of speech that most closely matching the customer pace of speech;
configuring the network to cause the selected agent, via the selected agent's respective agent communication device, to join the communication
accessing the content of the communication at a time after the selected agent was joined to the communication;
accessing a customer attribute from the storage;
determining, from a rule in the storage, the customer pace of speech from the customer attribute;
determining the content of the communication comprises an indication, from the customer, that the agent pace of speech of the selected agent is in discord with the customer pace of speech;
in response to the discord, modifying the rule to attenuate the discord; and
causing the storage to store the modified rule and utilize the modified rule as the rule in a subsequent communication.

2. (canceled)

3. The system of claim 1, wherein the customer attribute comprises a demographic attribute associated with a demographic of the customer.

4. The system of claim 1, wherein the microprocessor further performs:
accessing a default customer pace of speech from the storage;
determining a customer pace of speech change comprising an increase-decrease indicator and an amount from the customer attribute; and
determining the customer pace of speech as the default customer pace of speech as modified by the customer pace of speech change.

5. (canceled)

6. The system of claim 1, wherein the microprocessor further performs:
in response to the discord, modifying the customer attribute to attenuate the discord; and
causing the storage to store the modified customer attribute and utilize the modified customer attribute as the customer attribute in a subsequent communication.

7. The system of claim 1, wherein the customer attribute comprises a demographic attribute associated with the customer and wherein the modified customer attribute comprises a modification to at least a portion of the demographic attribute.

8. The system of claim 1, wherein the customer pace of speech is determined from one or more of age of the customer, native language of the customer, native residence of the customer, or occupation of the customer.

9. The system of claim 1, wherein the customer pace of speech is determined from a temporal attribute associated with, at least one of, the time of day the customer originated the communication, the day of the week the customer originated the communication, the day of the month the customer originated the communication, or a device type utilized by the customer to originate the communication.

10. The system of claim 1, wherein at least one of the customer pace of speech and the agent pace of speech for the number of agents is determined as the output of computer-executed instructions and without any human input.

11. A method, comprising:
accessing a communication, utilizing a network, with a customer communication device associated with a customer and comprising an audio portion;
accessing a customer pace of speech associated with the customer;
accessing an agent pace of speech associated with each of a number of agents available to join the communication via their respective agent communication device;
selecting an agent, from the number of agents, that has the associated agent pace of speech that most closely matching the customer pace of speech;
configuring the network to cause the selected agent, via the selected agent's respective agent communication device, to join the communication;
accessing a customer attribute from a data storage device;
determining, from a rule in a data storage device, the customer pace of speech from the customer attribute;
in response to the discord, modifying the customer attribute to attenuate the discord; and
causing the data storage device to store the modified customer attribute and utilize the modified customer attribute as the customer attribute in a subsequent communication.

12. (canceled)

13. The method of claim 11, wherein the customer attribute comprises a demographic attribute associated with a demographic of the customer.

14. The method of claim 11, further comprising:
accessing a default customer pace of speech from the data storage device;
determining a customer pace of speech change comprising an increase-decrease indicator and an amount from the customer attribute; and
determining the customer pace of speech as the default customer pace of speech as modified by the customer pace of speech change.

15. The method of claim 11, further comprising:
in response to the discord, modifying the rule to attenuate the discord; and
causing the data storage device to store the modified rule and utilize the modified rule as the rule in a subsequent communication.

16. (canceled)

17. The method of claim 11, wherein the customer attribute comprises a demographic attribute associated with the customer and wherein the modified customer attribute comprises a modification to at least a portion of the demographic attribute.

18. The method of claim 11, wherein the customer pace of speech is determined from a temporal attribute associated with, at least one of, the time of day the customer originated the communication, the day of the week the customer originated the communication, the day of the month the customer originated the communication, or a device type utilized by the customer to originate the communication.

19. The method of claim 11, wherein at least one of the customer pace of speech and the agent pace of speech for the number of agents is determined as the output of computer-executed instructions and without any human input.

20. A system, comprising:
means to access a communication, utilizing a network, with a customer communication device associated with a customer and comprising an audio portion;
means to access a customer pace of speech associated with the customer;
means to access an agent pace of speech associated with each of a number of agents available to join the communication via their respective agent communication device;
means to select an agent, from the number of agents, that has the associated agent pace of speech that most closely matching the customer pace of speech;
means to configure the network to cause the selected agent, via the selected agent's respective agent communication device, to join the communication;
means to access the content of the communication at a time after the selected agent was joined to the communication;
means to access a customer attribute from a storage;
means to determine, from a rule in the storage, the customer pace of speech from the customer attribute;
means to determine the content of the communication comprises an indication, from the customer, that the agent pace of speech of the selected agent is in discord with the customer pace of speech;
means to, in response to the discord, modify the rule to attenuate the discord; and
means to cause the storage to store the modified rule and utilize the modified rule as the rule in a subsequent communication.

21. The system of claim 20, wherein the customer attribute comprises a demographic attribute associated with the customer and wherein the means to modify the customer attribute further comprises means to modify at least a portion of the demographic attribute.

22. The system of claim 20, wherein the means to determine the customer pace of speech further comprise means to determine one or more of age of the customer, native language of the customer, native residence of the customer, or occupation of the customer.

23. The system of claim 20, wherein the means to determine the customer pace of speech further comprise means to determine a temporal attribute associated with, at least one of, the time of day the customer originated the communication, the day of the week the customer originated the communication, the day of the month the customer originated the communication, or a device type utilized by the customer to originate the communication.

24. The system of claim 20, wherein the means to determine at least one of the customer pace of speech and the agent pace comprise the output of computer-executed instructions without any human input.
